(19) United States
(12) Patent Application Publication
(10) Pub. No.: US 2017/0151561 A1
(43) Pub. Date: Jun. 1, 2017

(54) REINFORCED MICROPLATE

(71) Applicant: CORNING INCORPORATED, Corning, NY (US)

(72) Inventors: William Joseph Lacey, North Andover, MA (US); Gregory Roger Martin, Acton, ME (US); Wai Kin Poon, Union City, CA (US); Ramana Tadepalli, San Ramon, CA (US); Joseph Christopher Wall, Southborough, MA (US); Hongming Wang, Kennebunk, ME (US)

(21) Appl. No.: 15/319,993

(22) PCT Filed: Jun. 26, 2015
(86) PCT No.: PCT/US2015/037968

§ 371 Date: Dec. 19, 2016

Related U.S. Application Data
(60) Provisional application No. 62/017,590, filed on Jun. 26, 2014.

(51) Int. Cl. B01L 3/00

(52) U.S. Cl. CPC B01L 3/50851; B01L 2200/025; B01L 2200/12; B01L 2300/0829

(57) ABSTRACT

A microplate is fitted with a reinforcing member that enhances the rigidity of the microplate and decreases the magnitude of thermally-induced deformation. An example reinforced microplate includes a deck including a plurality of wells formed therein, and a reinforcing member attached to an underside of the deck.

### CROSS-REFERENCE TO RELATED APPLICATIONS

This application claims the benefit of priority under 35 U.S.C. §119 of U.S. Provisional Application Ser. No. 62/017590 filed on Jun. 26, 2014 the content of which is relied upon and incorporated herein by reference in its entirety.

### BACKGROUND

Field

The present disclosure relates generally to microtiter plates, also known as microplates, and more particularly to reinforced microplates and their methods of manufacture. The reinforced microplates are adapted for use with automated equipment and can withstand thermal cycling without unacceptable deformation.

Technical Background

Polymerase chain reaction (PCR) processes involve the replication of genetic material such as DNA and RNA. In both industry and academia, PCR processes are carried out on a large scale using multi-well microplates (e.g., 8 well strips or 96, 384 or even 1536 well arrays). It is desirable to have an apparatus that allows the PCR process to be performed in an efficient and convenient fashion.

Because of their ease of handling and relatively low cost, microplates are often used for sample containment during the PCR process. Microplates may also be used in other research and clinical diagnostic procedures. Reference is made to FIGS. 1A-1C where there are illustrated different views of an example conventional microplate 100. Microplate 100 is formed from a polymeric material (e.g., polypropylene) and includes an array of conical or bullet-shaped wells 102 in deck 106 each configured to contain a small sample volume. Polypropylene has few extractables to interfere with the PCR process.

In accordance with the PCR process, a small quantity of genetic material and a solution of reactants are deposited within each well 102. The microplate 100 is then placed in a thermocycler, which operates to increase and decrease the temperature of the contents within the wells. In an example PCR process, the microplate 100 is placed on a metal heating fixture within the thermocycler. To provide good thermal contact and precise temperature control, the heating fixture is sized and shaped to closely conform to the underside of the microplate 100 and, in particular, to the exterior portion of the wells 102. A heated top plate of the thermocycler clamps the microplate onto the heating fixture while the well contents are repeatedly heated and cooled.

Because the microplate 100 is typically made from a non-thermally-conductive polymeric material, the walls 104 of the wells 102 are configured to be as thin as possible in order that the thermocycler can effectively heat and cool the contents in the wells 102. As a result, however, the relatively thin well walls 104 are inclined to deform in response to the repeated thermal cycling. In order to accommodate the deformation, conventional microplates are formed using relatively non-rigid materials such as polypropylene. Unfortunately, polypropylene tends to strain in response to thermally-induced stress.

As a result of the deformation of the relatively thin well walls 104 and the tendency of the microplate 100 to change dimensions during thermal cycling, it may be difficult to remove a traditional microplate 100 from the thermocycler. Notably, as the number of wells 102 (and the overall size) of the microplate 102 increases, the force required to remove the microplate 100 from the thermocycler increases, which further deforms the article. Moreover, robotic handling systems may have difficulty manipulating the microplate 100 and removing the relatively thin traditional microp late 100 from the thermocycler. In addition, the plate deck may thermally degrade as a result of the thermal cycling. Such degradation may further contribute to warping or twisting of the plate.

Accordingly, there is a need for a microplate free of the aforementioned shortcomings.

### BRIEF SUMMARY

In accordance with embodiments of the present disclosure, a microplate is provided with a reinforcing member such as a reinforcing strip or a reinforcing frame. The reinforcing member may be attached to the microplate at an underside (i.e., backside) of the deck. Methods for attaching the reinforcing member to the microplate include overmolding, ultrasonic welding, laser welding, hotplate welding or riveting one material to the other, for example, using pre-molded posts. The reinforcing member may be held in place with a snap or undercut fit. While the microplate, including the wells and adjacent deck, is formed from a relatively non-rigid material such as polypropylene, the reinforcing member is formed from a higher working temperature and overall higher strength material.

The reinforcing member may be formed from a glass, ceramic, glass-ceramic or high-temperature polymer or polymer blend. The reinforcing member may be a composite material. Example materials for the reinforcing member include glass- or mineral-filled polypropylene, polysulfone, polyphenylene sulfide, polycarbonate, and polycarbonate blends such as acrylonitrile butadiene styrene mixed with polycarbonate and polybutylene terephthalate mixed with polycarbonate. Such materials have a higher working temperature than polypropylene. The reinforcing member enhances the rigidity of the microplate and decreases the strain impact of thermally-induced stresses.

As disclosed in various embodiments, a reinforced microplate comprises a deck including a plurality of wells formed therein, and a reinforcing member attached to an underside of the deck. In embodiments, the reinforced microplate is a reinforced PCR plate.

Additional features and advantages of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure, and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIGS. 1A-1C respectively illustrate a perspective view, a cut-away partial perspective view, and a cross-sectional side view of a conventional microplate;

FIGS. 2 and 2A-2C are perspective views of an example thermocycler capable of heating and cooling the reinforced microplates disclosed herein;

FIG. 3 is a schematic view of a reinforcing member according to embodiments;

FIG. 4 is an exploded view of a reinforced microplate showing the microplate deck and the reinforcing member;

FIG. 5 is a phantom view of a reinforced microplate comprising a peripheral reinforcing member in position under the microplate deck;

FIG. 6 is a bottom view of the reinforced microplate of FIG. 5;

FIG. 7 is a phantom view of a reinforced microplate comprising a reinforcing member with support ribs;

FIG. 8 is a phantom view of a reinforced microplate comprising a peripheral reinforcing member attached under the microplate deck via locking tabs;

FIG. 9 is a bottom view of the reinforced microplate of FIG. 8 showing the locking tabs;

FIG. 10 is a schematic view of a reinforcing member according to further embodiments;

FIG. 11 is a phantom view of a reinforced microplate comprising the reinforcing member of FIG. 10 in position under the microplate deck;

FIG. 12 is a bottom view of the reinforced microplate of FIG. 11;

FIG. 13 is a perspective view of a reinforced microplate according to embodiments;

FIG. 14 is a top view of the reinforced microplate of FIG. 13;

FIG. 15 is a bottom view of the reinforced microplate of FIG. 13;

FIG. 16 is a side view of the reinforced microplate of FIG. 13 showing a reinforcing member held in position under the microplate deck with locking tabs;

FIG. 17 is a schematic view of a reinforcing member having a locking rim;

FIG. 18 is a schematic view of a reinforcing member having locking tabs;

FIG. 19 is a schematic view of a reinforcing member having pockets configured to engage with locking tabs formed in a microp late;

FIG. 20 is a schematic view of a reinforcing member having reinforcing ribs;

FIG. 21 is a view of a reinforced microplate comprising a peripheral reinforcing member;

FIG. 22 is a cut-away partial perspective view of the reinforced microplate of FIG. 21;

FIG. 23 is a schematic view of a reinforcing member having locking tabs used in conjunction with the reinforced microplate of FIG. 21;

FIG. 24 is a perspective view of a reinforced microplate according to embodiments;

FIG. 25 is a bottom view of the reinforced microplate of FIG. 24 comprising a peripheral reinforcing member attached via rivets; and

FIG. 26 is a cut-away partial perspective view of the reinforced microplate of FIG. 24.

### DETAILED DESCRIPTION

Reference will now be made in greater detail to various embodiments of the subject matter of the present disclosure, some embodiments of which are illustrated in the accompanying drawings. The same reference numerals will be used throughout the drawings to refer to the same or similar parts.

A microplate is fitted with a reinforcing member that enhances the rigidity of the microplate and decreases the magnitude of thermally-induced deformation. In embodiments, a reinforced microplate comprises a deck including a plurality of wells formed therein, and a reinforcing member attached to an underside of the deck. In embodiments, the reinforcing member is attached to underside of the deck, peripheral to the plurality of wells.

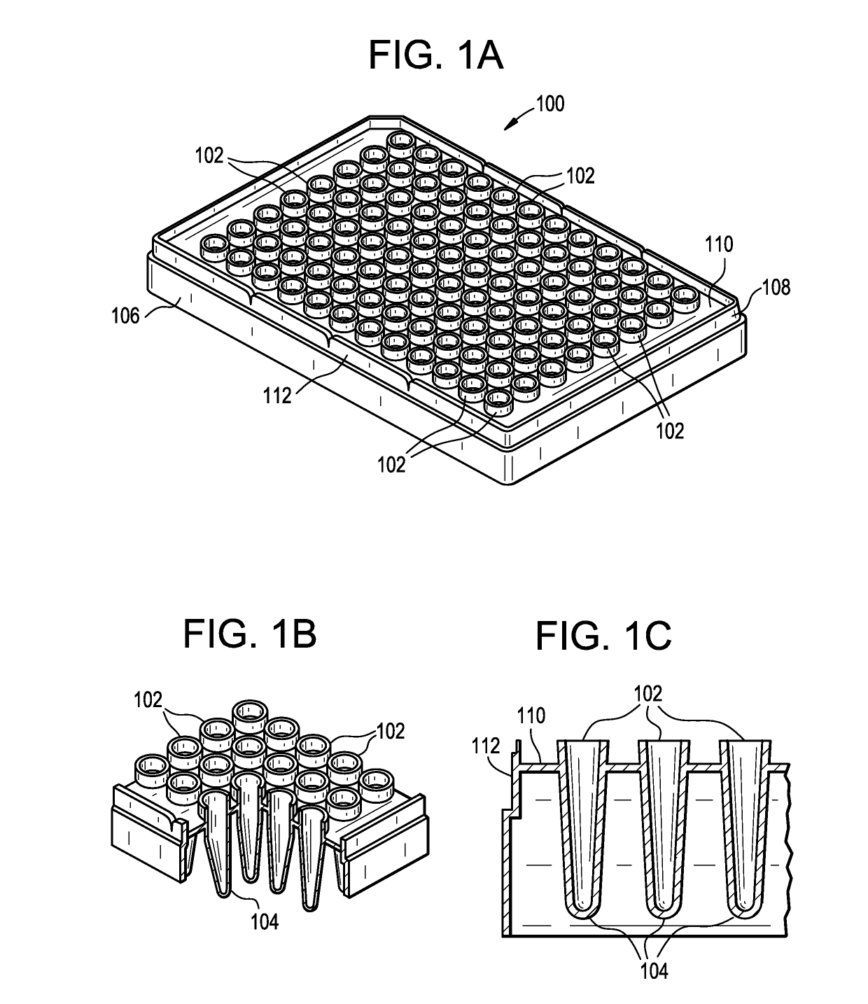

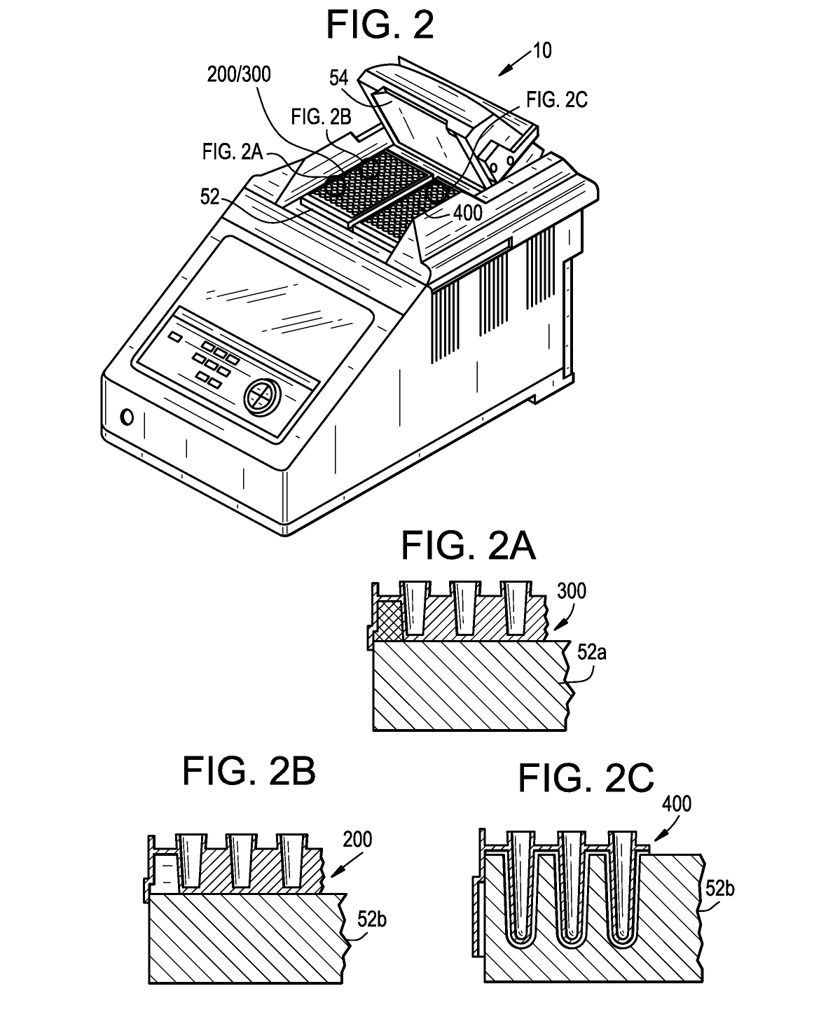

Referring to FIG. 1A-1C, there are illustrated different views of a microplate 100. The microp late 100 includes a deck 106 that is manufactured from a polymeric material. In the illustrated embodiment, the deck 106 supports an array of ninety-six wells 102. The deck 106 as shown has a rectangular shape and includes an outer wall 108 and a top planar surface 110 extending in part between the outer wall 108 and the wells 102. It should be understood that the deck 106 can be provided in any number of other geometrical shapes (e.g., square or triangular) depending, for example, on the desired arrangement of the wells. The outer wall 108 also has a rim 112 to accommodate the skirt of a microplate cover (not shown). The microplate is configured to be placed within a thermocycler 10 as described in greater detail below with reference to FIG. 2.

Referring to FIG. 2, there is a perspective view of an exemplary thermocycler 10 capable of heating and cooling one or more reinforced microplates 200, 300, 400, etc. In accordance with the PCR process, a small quantity of genetic material and a solution of reactants are deposited within one or more microplate wells. Optionally, the microplate is covered or sealed to inhibit the evaporation of the contents within the wells. Thereafter, the reinforced microplate is placed in the thermocycler 10, which operates to cycle the temperature of (i.e., repeatedly heat and cool) the content within the wells.

As illustrated, reinforced microplates 200, 300 are positioned onto a metal heating fixture 52 such as heating fixture 52a in the example of a MJ Alpha-1200 thermocycler. The metal heating fixture 52a can be relatively flat to conform to flat-bottomed wells. In a further embodiment, a reinforced microplate 400 can be positioned onto a metal heating fixture 52b such as in the example of a GeneAmp® PCR System 9700. The metal heating fixture 52b has a series of cavities that are shaped to closely conform to the exterior dimensions of the wells. The thermocycler 10 also has a heated top plate 54 (shown in the open position) that clamps the reinforced microplates 200, 300 and 400 onto the metal heating fixtures 52a, 52b before the thermocycler repeatedly heats and cools the well contents. For instance, the thermocycler 10 can cycle the temperature of the contents within the wells over a temperature range of 25° C. to 95° C. as many as thirty times during the PCR process, which may have duration of up to 4 hours, e.g., 0.5, 1, 2, 3, or 4 hrs. During a typical PCR process, the temperature of the top plate is held constant (e.g., 100° C.) to minimize condensation while the temperature of the heating fixture is cycled. This temperature differential may exacerbate distortion or warping of the PCR plate.

The use of a reinforced microplate having a rigid structure makes it easy for a scientist or robot handling system to remove the microplate from the thermocycler 10 after completion of the PCR process. This is a marked improvement over the traditional microplate 100 that had a tendency to deform and/or adhere to the metal heating fixtures 52a/52b. Although the reinforced microplate is described as being used in a PCR process, it should be understood that the microplate can be used in a wide variety of processes. The reinforced microplate, according to embodiments, is a reinforced PCR plate. A PCR plate may be non-skirted, semi-skirted, or a full-skirted plate.

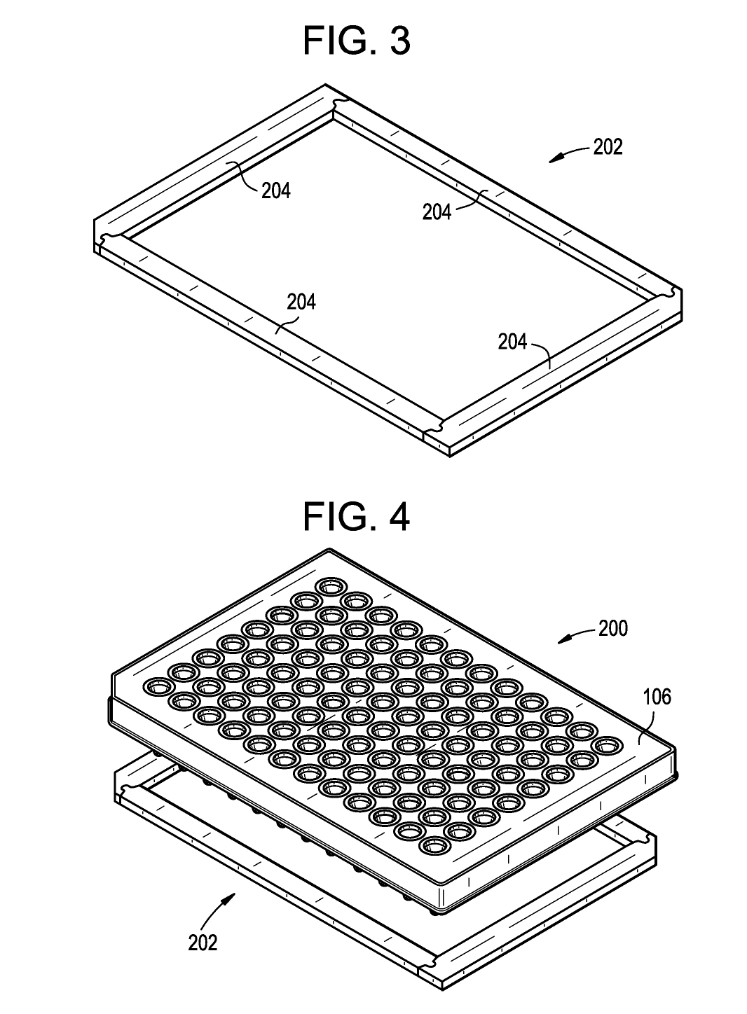

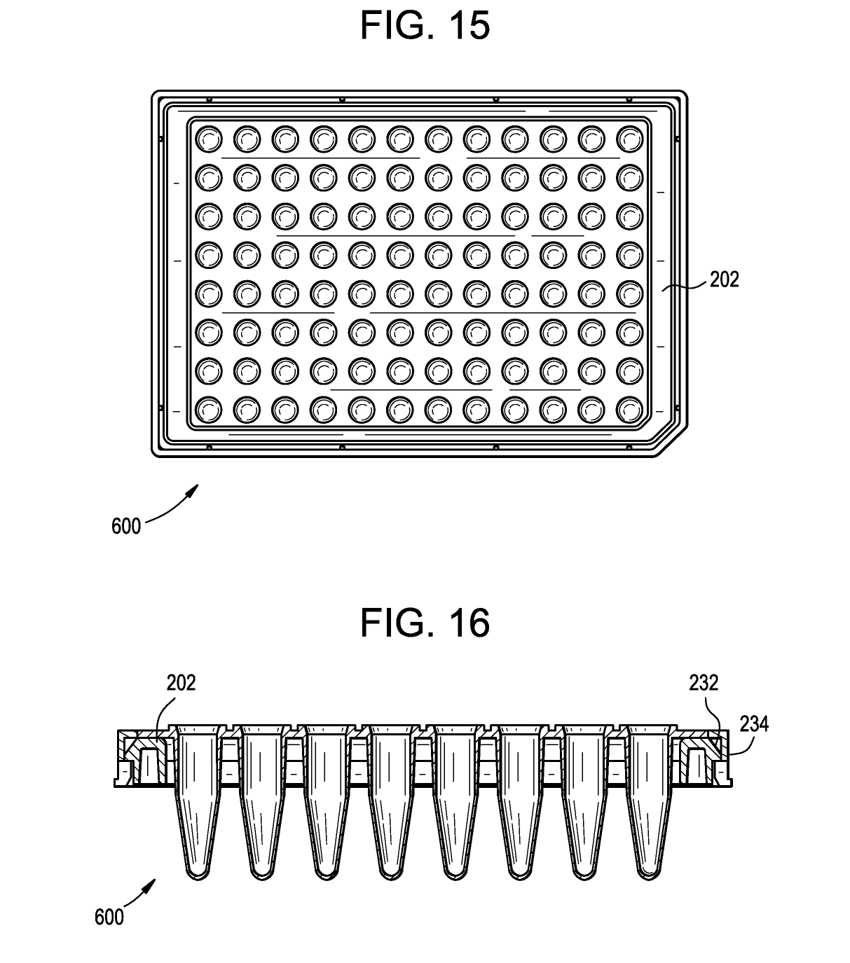

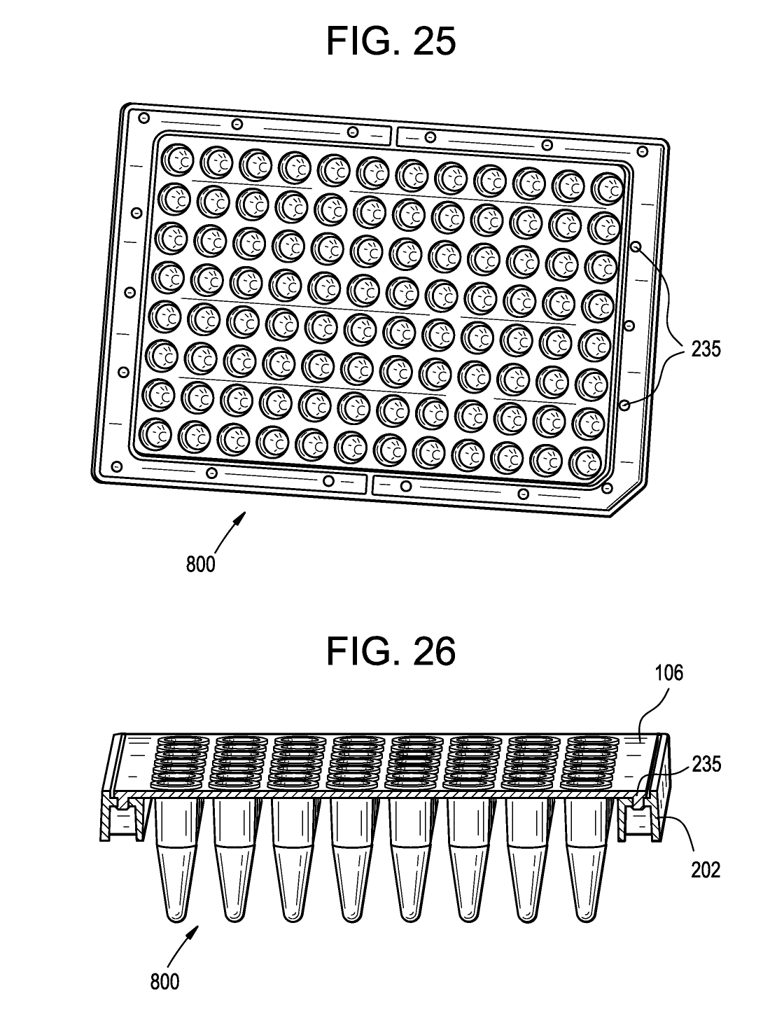

Aspects of the reinforced microplates, which include a reinforcing member, are disclosed herein with reference to FIGS. 3-26. A reinforcing member supports the microplate in a manner that makes the microplate more rigid and resistant to thermally-induced strain (i.e., deformation) so the microplate can be efficiently handled by an operator or a robotic handling system.

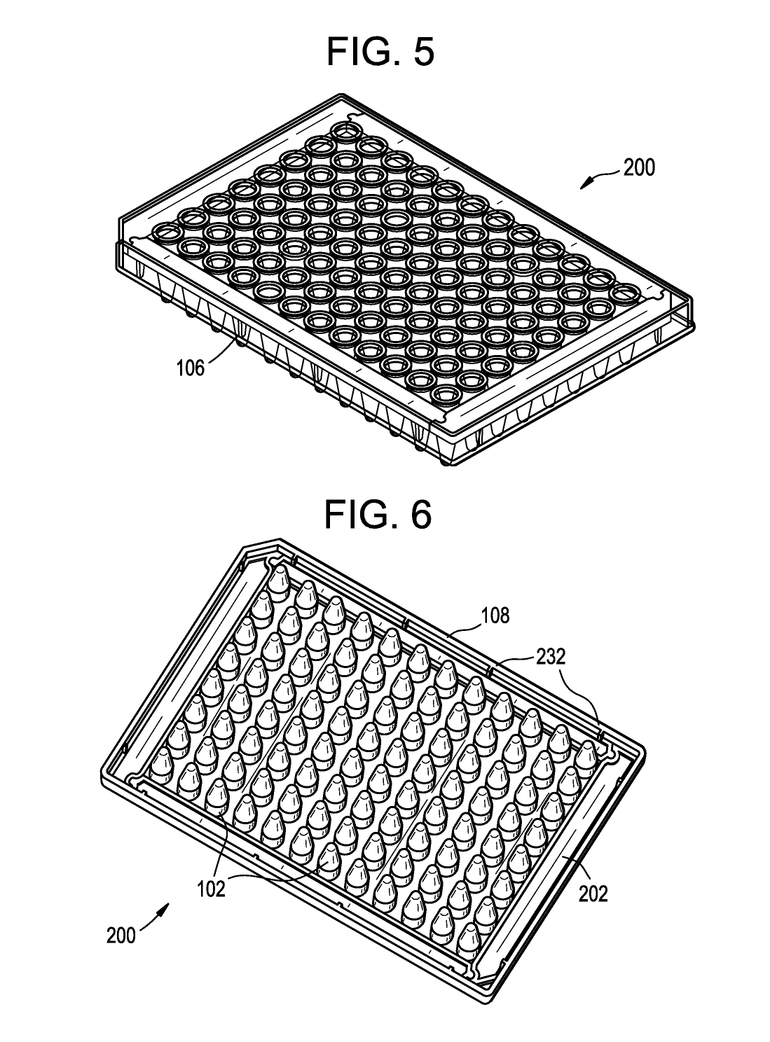

An example reinforcing member 202 is depicted in FIG. 3. The illustrated reinforcing member is assembled from a plurality of (e.g., four) ribs 204, which can comprise glass, carbon fiber, mineral-filled polypropylene or another high-strength polymer such as polycarbonate, polysulfone, or polymer blends such as ABS/polycarbonate or PBT/polycarbonate blends. As shown in FIGS. 4-6, the assembled reinforcing member 202 is attached to the underside of the deck 106 between the deck outer wall 108 and the wells 102, and held in place by a plurality of locking tabs 232 to form a reinforced microplate 200 according to one embodiment. FIG. 4 is an exploded perspective view of the reinforced microplate 200. FIG. 5 is a corresponding phantom perspective view, and FIG. 6 is a bottom perspective view showing the peripheral placement of the reinforcing member 202.

The reinforcing member 202 can be formed and/or held in place by over molding, ultrasonic welding, hotplate welding or laser welding. If the microplate deck 106 and the reinforcing member 202 are made from incompatible bonding materials, the reinforcing member can be riveted or snap-fit into place. When in place, the reinforcing member minimizes distorting or warping of the reinforced microplate due to thermocycling.

Referring still to FIG. 6, locking tabs 232 may be formed in the outer walls 108 of the microplate deck 106. Such locking tabs provide a snap-fit for the reinforcing member, which is held in place between a plurality of the wells, the outer walls, the lower surface of the deck and the locking tabs.

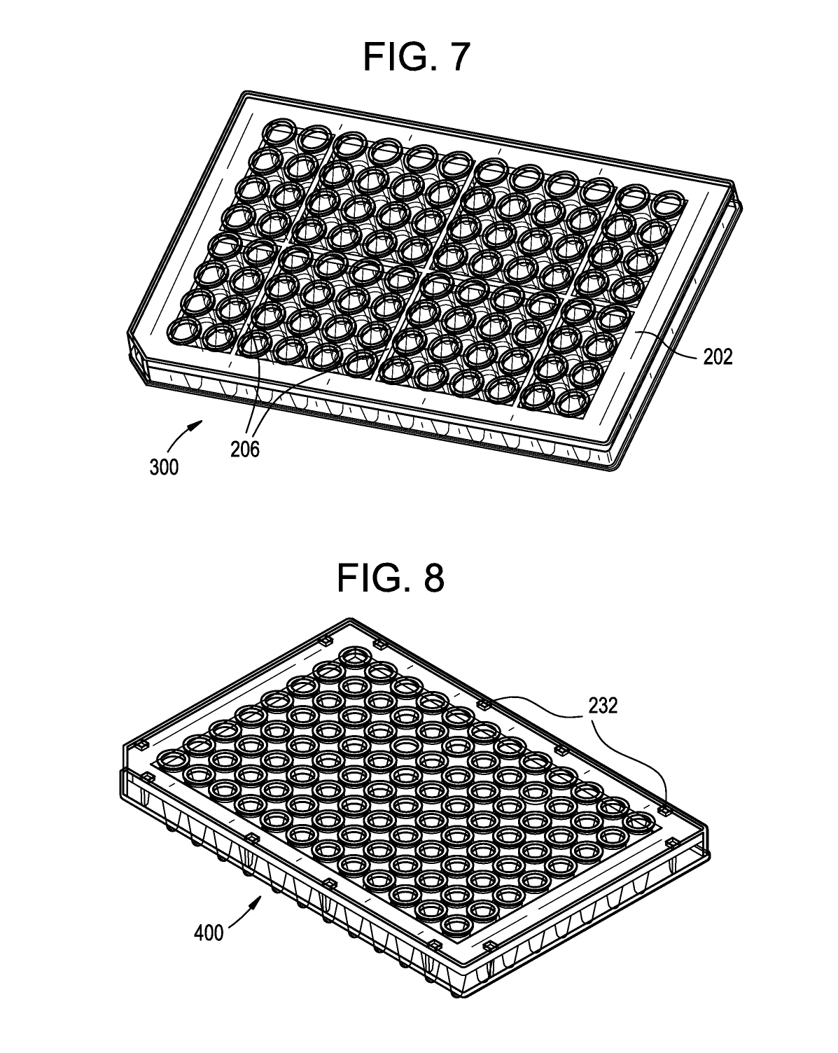

A reinforcing member 202 according to a further embodiment is depicted in FIG. 7, which is a phantom view showing placement of the reinforcing member. The illustrated reinforcing member 202 is a unitary part formed, for example, by injection molding and includes cross members 206 that provide additional support. Cross members 206 can act as runners during the injection molding process. Reinforcing member 202 is attached to the underside of the deck 106 and held in place by a plurality of locking tabs 232 to form a reinforced microplate 300 according to a further embodiment.

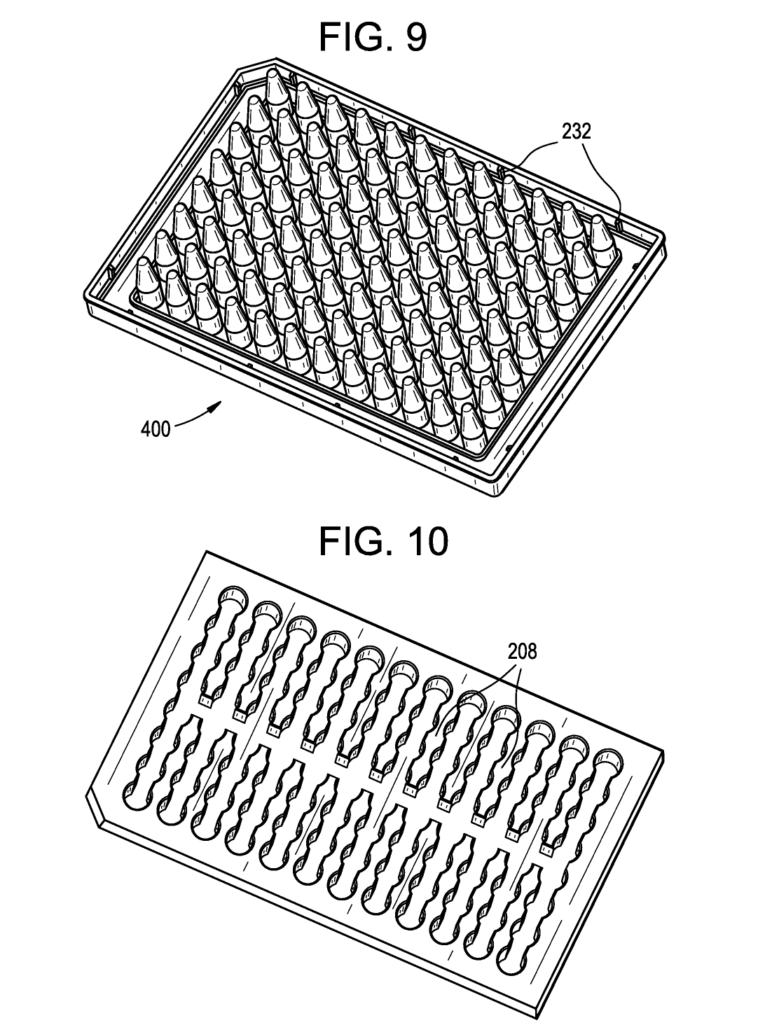

Additional views showing plural locking tabs 232 formed in the deck of the microplate and engaging a reinforcing member 202 are shown in FIGS. 8 and 9. In the embodiment of FIGS. 8 and 9, which respectively show phantom and bottom views of a reinforced microplate 400, the illustrated reinforcing member 202 is a unitary part where cross members are omitted.

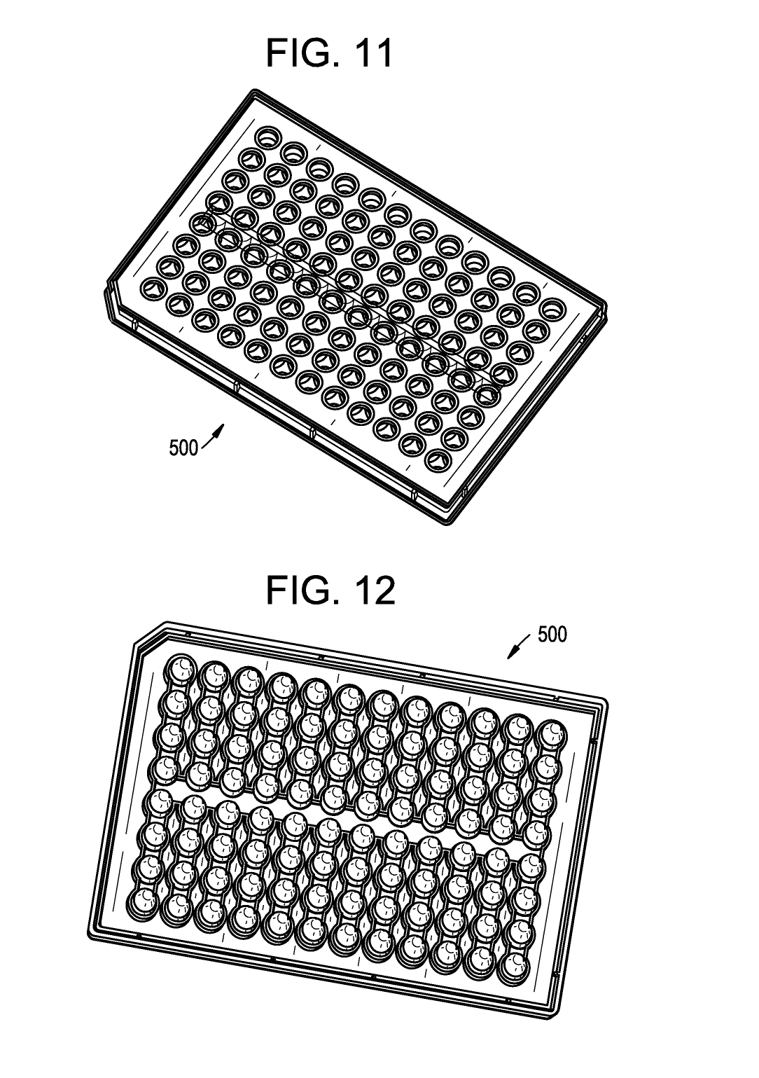

A reinforcing member 202 and associated reinforced microplate 500 according to a still further embodiment are depicted in FIGS. 10-12. The illustrated reinforcing member 202 in FIG. 10 is a unitary part formed, for example, by injection molding and includes fingers 208 that provide additional support to the assembled reinforced microplate. Fingers 208 extend inwardly along parallel axes from peripheral portions of the reinforcing member and, like the cross members of the previous embodiment, are configured to extend along the backside of the microplate plate deck between respective wells (see also FIGS. 11 and 12, which respectively show a phantom perspective view and a bottom perspective view of reinforced microplate 500).

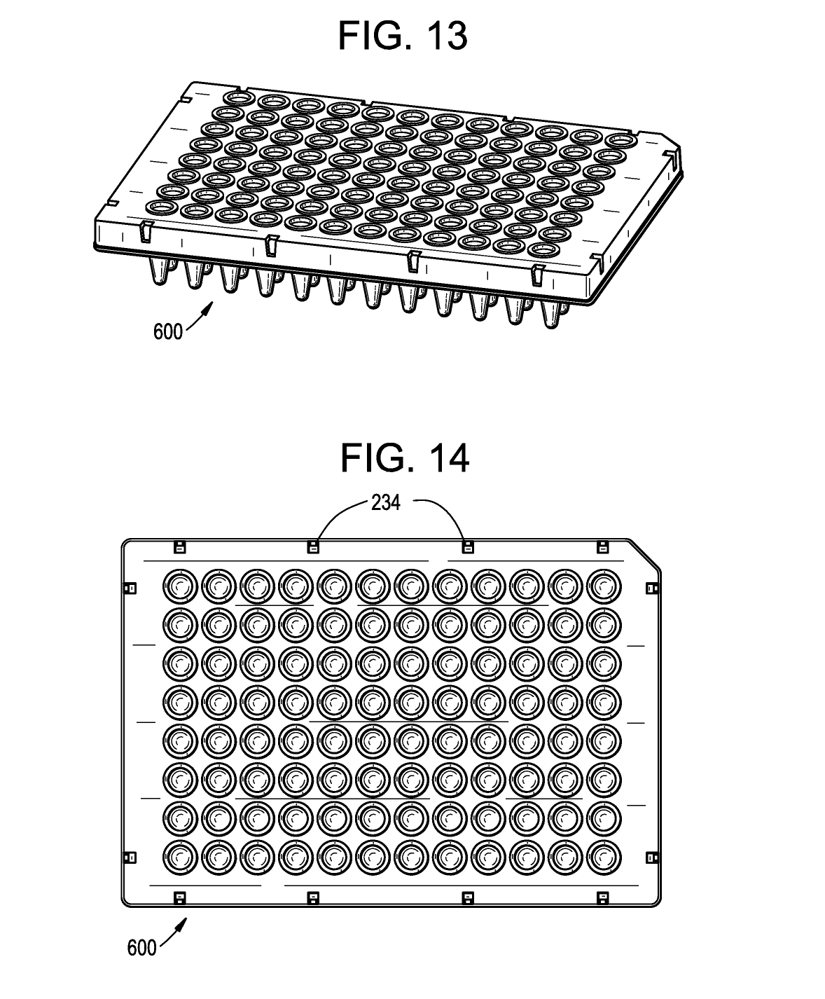

Turning to FIGS. 13-16, depicted is a reinforced microplate 600 and associated reinforcing member 202. The reinforcing member comprises a plurality of locking tabs 232 and microplate outer walls 108 comprise a respective plurality of locking slots 234. In embodiments, the locking slots 234 are apertures that extend through the outer wall 108 of the microplate deck 106. In contrast to the embodiments illustrated in FIG. 6 and FIG. 9, the locking tabs 232 of the instant embodiment are formed in an outer peripheral surface of the reinforcing member 202 rather than in an inner surface of the microplate deck. In an assembled reinforced microplate 600, locking tabs 232 engage with locking slots 234, e.g., in a snap-fit configuration, to hold the reinforcing member 202 in place against an underside of the deck. This assembly is illustrated in cross-section in FIG. 16. Also depicted in FIG. 16 is the U-shaped cross-section of reinforcing member 202.

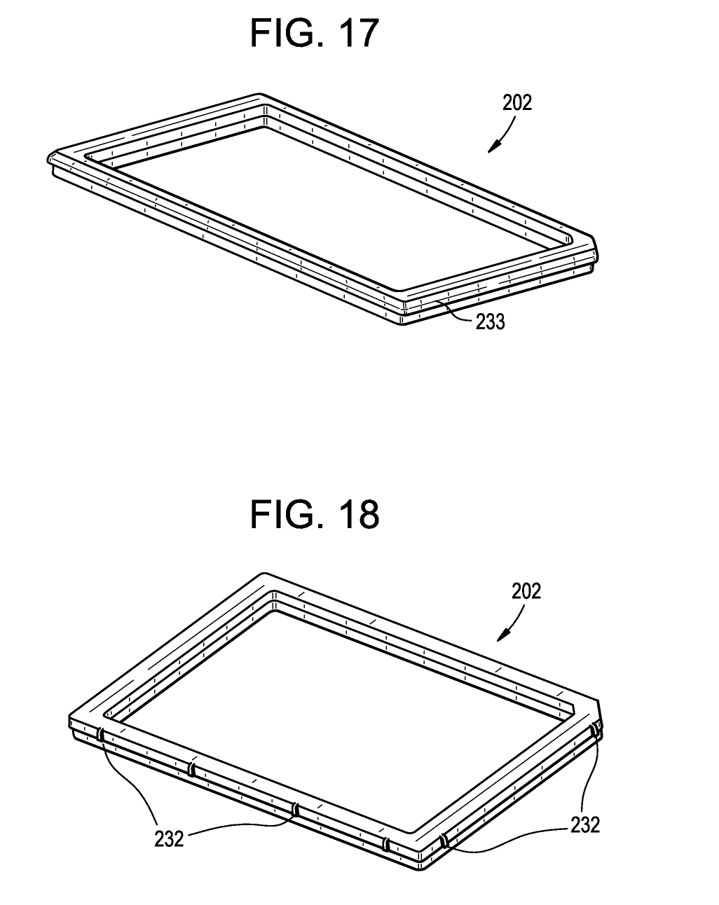

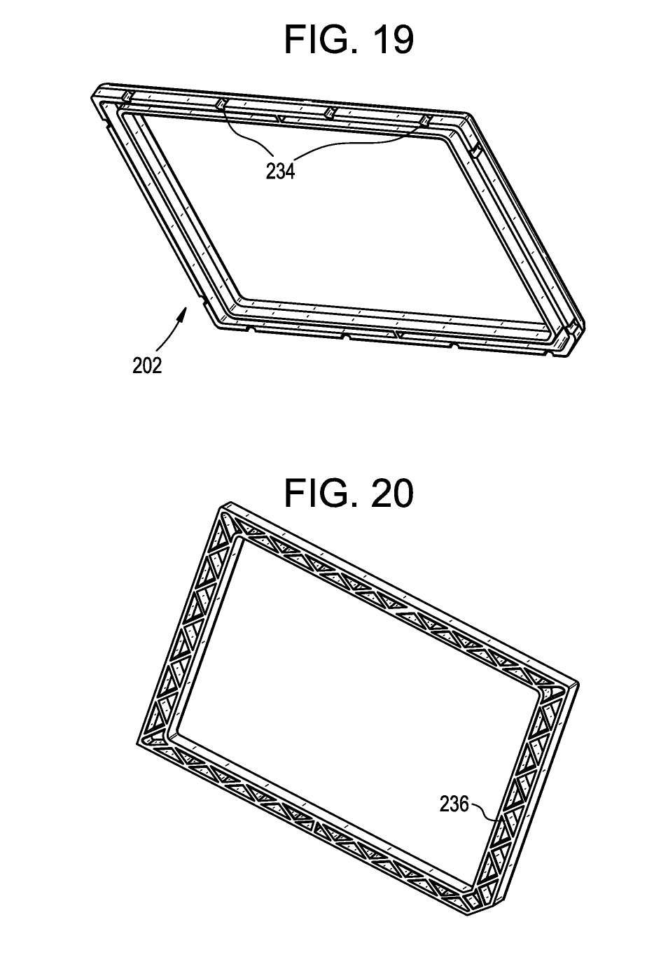

Reinforcing members according to various embodiments are illustrated in FIGS. 17-20. In FIG. 17, reinforcing member 202 comprises a peripheral rabbet (i.e., protruding edge) 233 adapted to engage with a corresponding receding edge formed in a microplate deck. Such edges can interlock to hold the reinforcing member in place. In FIG. 18, reinforcing member 202 comprises a plurality of locking tabs 232 adapted to engage with a plurality of locking slots 234 formed in a microplate deck. FIG. 19 shows a reinforcing member 202 comprising a plurality of locking slots 234 adapted to engage with a plurality of locking tabs 232 formed in a microplate deck. FIG. 20 shows a reinforcing member that comprises reinforcing ribs 236. Reinforcing ribs 236 are formed within the U-shaped cross-section of the reinforcing member.

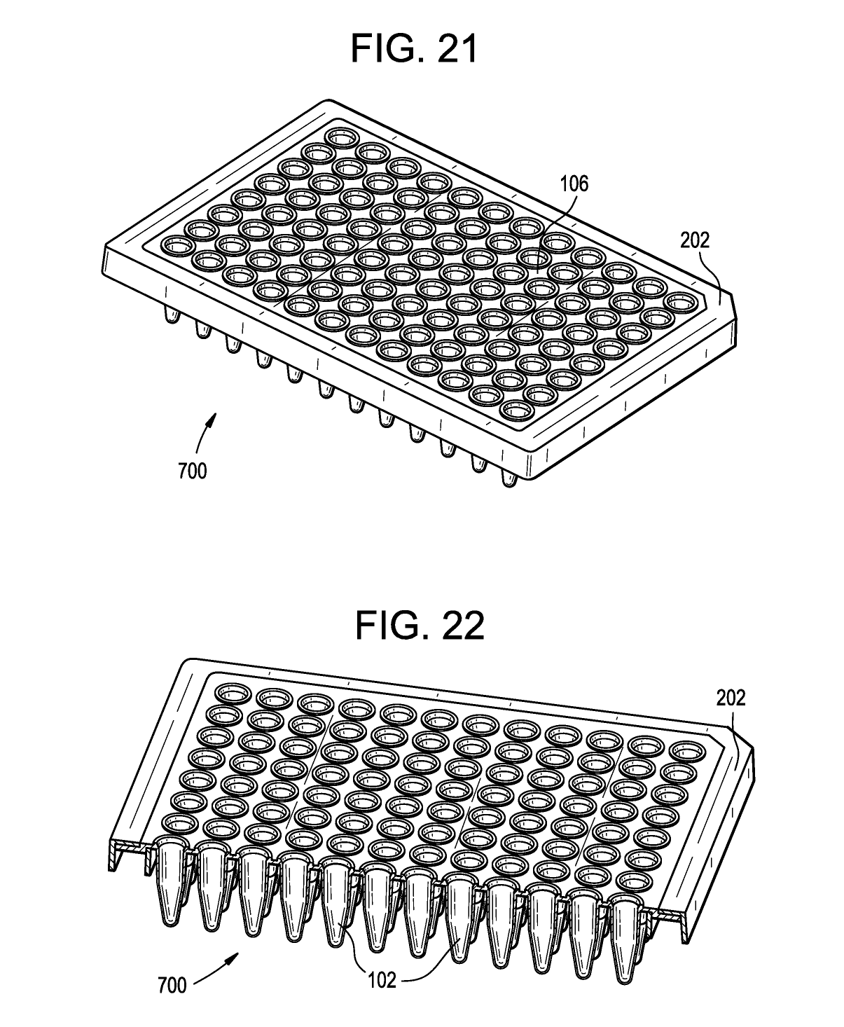

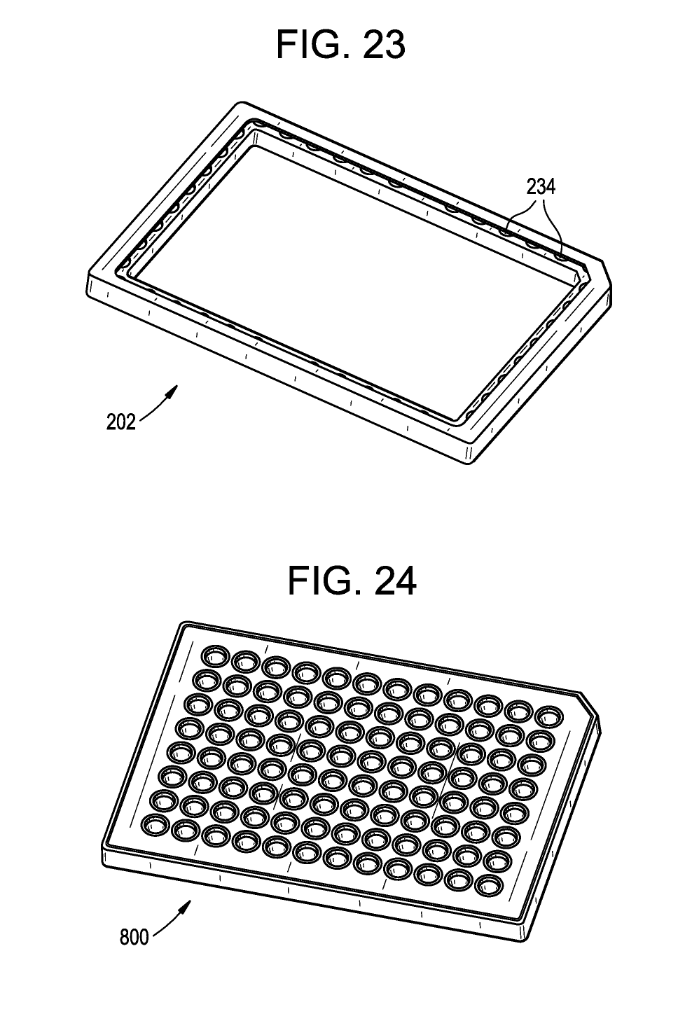

A further embodiment of a reinforced microplate 700 is illustrated in connection with FIGS. 21-23. Reinforced microplate 700 can be formed by overmolding or co-molding reinforcing member 202 with the microplate deck 106. FIG. 21 is a perspective view of a reinforced microplate comprising a peripheral reinforcing member, and FIG. 22 is a cut-away partial perspective view of the reinforced microplate of FIG. 21. Depicted in FIG. 23 is a perspective view of reinforcing member 202 showing a plurality of locking slots 234, which engage with the microplate deck 106 during the overmolding or co-molding process to lock the deck into the reinforcing member.

FIGS. 24-26 illustrate an example reinforced microplate 800 where the microplate deck 106 and reinforcing member 202 are molded in separate operations and then assembled by riveting or swaging locking pins 235 to the reinforcing member 202 to attach the reinforcing member 202 to the backside of the deck. In the illustrated embodiment, locking pins 235 are formed on the backside of the microplate deck 106.

In embodiments, the microplate deck, and in particular the well walls, is formed from a transparent material. As used herein, “transparent” means at least 60% transparency (e.g., at least 60, 65, 70, 75, 80, 82, 84, 86, 88, 90, 92, 94, 96, 98, 99 or 100% transparency) for a given wavelength or over a range of wavelengths. In embodiments, the well walls are transparent to visible light (i.e., over the wavelength range of 390 to 700 nm). In embodiments, the well walls are transparent to ultraviolet and/or near-infrared radiation (i.e., over the respective wavelength ranges of 100 to <390 nm and >700 to 2500 nm).

In embodiments, the microplate deck, and in particular the well walls, are characterized by low background fluorescence. Fluorescence is a form of absorbed energy that is reradiated at a lower energy, often as light. The amount of fluorescence (or lack thereof) from reinforced microplates is a key factor in their implementation with, for example, analytical spectroscopy, polarization and imaging, including point-of-care (POC) in vitro diagnostic tests, and other life-sciences analytics such as cellular flow cytometry.

The reinforcing member, which is formed from a different material than the microplate deck and wells, is incorporated below the microplate deck and maintains the dimensional integrity of the microplate during use, including during thermal cycling. The reinforcing member may be formed from a transparent material and/or characterized by low background fluorescence.

As used herein, the singular forms “a,” “an” and “the” include plural referents unless the context clearly dictates otherwise. Thus, for example, reference to a “reinforcing member” includes examples having two or more such “reinforcing members” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a reinforcing member comprising polycarbonate include embodiments where a reinforcing member consists of polycarbonate and embodiments where a reinforcing member consists essentially of polycarbonate.

It will be apparent to those skilled in the art that various modifications and variations can be made to the present invention without departing from the spirit and scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

We claim:

1. A reinforced microplate comprising,
a deck including a plurality of wells formed therein, and
a reinforcing member attached to an underside of the deck.

2. The reinforced microplate according to claim 1, wherein the reinforced microplate is a PCR plate.

3. The reinforced microplate according to claim 1, wherein the reinforcing member is attached peripheral to the plurality of wells.

4. The reinforced microplate according to claim 1, wherein the reinforcing member comprises support ribs that extend between wells.

5. The reinforced microplate according to claim 1, wherein the deck comprises polypropylene.

6. The reinforced microplate according to claim 1, wherein the reinforcing member comprises a material selected from the group consisting of glass-filled polypropylene, mineral-filled polypropylene, polysulfone, polyphenylene sulfide, polycarbonate, a mixture of acrylonitrile butadiene styrene with polycarbonate, and a mixture of polybutylene terephthalate with polycarbonate.

7. The reinforced microplate according to claim 1, wherein the reinforcing member is a unitary part.

8. The reinforced microplate according to claim 1, wherein the reinforcing member comprises a plurality of ribs.

9. The reinforced microplate according to claim 1, wherein the reinforcing member comprises a plurality of cross-members or fingers.

10. The reinforced microplate according to claim 1, wherein the reinforcing member comprises a plurality of locking tabs and the deck comprises a plurality of locking slots configured to engage with the locking tabs.

11. The reinforced microplate according to claim 1, wherein the deck comprises a plurality of locking tabs and the reinforcing member comprises a plurality of locking slots configured to engage with the locking tabs.

12. The reinforced microplate according to claim 1, wherein the reinforcing member comprises a U-shaped cross-section.

13. The reinforced microplate according to claim 1, wherein the deck and wells comprise an optically transparent material.

14. A method of forming a reinforced microplate, comprising:
forming a microplate deck comprising a plurality of wells, and
attaching a reinforcing member to an underside of the deck.

15. The method according to claim 14, wherein the reinforcing member is attached peripheral to the plurality of wells.

16. The method according to claim 14, wherein the deck comprises polypropylene and the reinforcing member comprises a material selected from the group consisting of glass-filled polypropylene, mineral-filled polypropylene, polysulfone, polyphenylene sulfide, polycarbonate, a mixture of acrylonitrile butadiene styrene with polycarbonate, and a mixture of polybutylene terephthalate with polycarbonate.

17. The method according to claim 14, wherein the attaching comprises riveting, swaging or snap-fitting.
